(19) United States
(12) Patent Application Publication
(10) Pub. No.: US 2024/0038197 A1
(43) Pub. Date: Feb. 1, 2024

(54) COMPENSATION METHOD FOR DISPLAY PANEL AND DISPLAY DEVICE

(71) Applicant: TCL CHINA STAR OPTOELECTRONICS TECHNOLOGY CO., LTD., Shenzhen, Guangdong (CN)

(72) Inventor: Yi Chen, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/622,848

(22) PCT Filed: Dec. 22, 2021
(86) PCT No.: PCT/CN2021/140421

§ 371 Date: Dec. 26, 2021

(30) Foreign Application Priority Data
Dec. 14, 2021 (CN) 202111526836.1

(51) Int. Cl. G09G 5/10

(52) U.S. Cl. CPC G09G 5/10; G09G 2320/0233; G09G 2360/16; G09G 2320/0285

(57) ABSTRACT

The present application provides a compensation method for a display panel and a display device. The compensation method for the display panel includes: acquiring a location information of an abnormally exposed area in a target panel; acquiring a compensation table corresponding to the target panel, and determining a value to be compensated corresponding to the location information of the abnormally exposed area in the compensation table according to the location information of the abnormally exposed area; setting a compensation data of a first area in the compensation table as a standard compensation value; and compensating the abnormally exposed area according to a difference between the value to be compensated and the standard compensation value.

### BACKGROUND OF INVENTION

### Field of Invention

The present application relates to a field of display technology, and in particular to a compensation method for a display panel and a display device.

### Description of Prior Art

With development of display technology, applications of display panels have become more and more extensive, and requirements for display effects of the display panels have become higher and higher. In a production process of the display panel, due to the overlapping exposed area between adjacent ones of the lenses in the exposure process, lens mura (display abnormality caused by the lens) will generate in a corresponding position on the display panel, wherein mura refers to phenomenon of various seams caused by uneven brightness of the display panel. In order to reduce or eliminate mura, a demura process can be used to compensate the display panel.

The demura process includes the following four steps: photographing, image processing, bin file generation, and bin copy. However, as demands for production capacity continues to increase, a demura ratio and a demura process flow need to be reduced to increase production capacity. However, for products that is not subjected to the demura process, an image quality needs to be ensured, and a solution of using a mean value of limited samples to copy may easily cause a shift in position of the lens mura, which is because a mean value processing will average influence factors of a total sample, resulting in lens mura generated in an position where there is no lens mura originally. Therefore, there is a need to improve such defects.

### SUMMARY OF INVENTION

An embodiment of the present application provides a compensation method for a display panel, which is used to solve the technical problem of a poor compensation effect of the display panel in the prior art caused by a shift in position of lens mura due to using a mean value of limited samples for compensation.

An embodiment of the present application provides a compensation method for a display panel, including: acquiring a location information of an abnormally exposed area in a target panel; acquiring a compensation table corresponding to the target panel, and determining a value to be compensated corresponding to the location information of the abnormally exposed area in the compensation table according to the location information of the abnormally exposed area; setting a compensation data of a first area in the compensation table as a standard compensation value, wherein the first area is located in a normally exposed area; and compensating the abnormally exposed area according to a difference between the value to be compensated and the standard compensation value.

In the compensation method for the display panel provided by an embodiment of the present application, the step of acquiring the compensation table corresponding to the target panel includes: acquiring a location information of each of the display panel in the display panel sample and a compensation value corresponding to each of the location information; determining a mean compensation value corresponding to each of the location information according to the location information of each of the display panel and the compensation value corresponding to each of the location information; and determining a compensation table corresponding to the target panel according to each of the location information and the mean compensation value corresponding to each of the location information.

In the compensation method for the display panel provided by an embodiment of the present application, the step of setting the compensation data of the first area in the compensation table as a standard compensation value, and the first area is located in the normally exposed area includes: determining a location information of the normally exposed area in the compensation table and a compensation data corresponding to the location information of the normally exposed area according to the location information of the abnormally exposed area in the compensation table; and selecting the compensation data of the first area in the normally exposed area to setting the compensation data of the first area as a standard compensation value.

In the compensation method for the display panel provided by an embodiment of the present application, the first area is a central area of the normally exposed area.

In the compensation method for the display panel provided by an embodiment of the present application, the step of compensating the abnormally exposed area according to the difference between the value to be compensated and the standard compensation value includes: setting a compensation factor, the compensation factor being a minimum compensation value; determining a quotient value of a difference divided by the compensation factor according to the difference between the value to be compensated and the standard compensation value; and calculating a variance of multiple quotient values; using a sum of a product of the quotient value multiplied by the compensation factor and the value to be compensated to compensate the abnormally exposed area when six times the variance is greater than or equal to 1; and using the value to be compensated to compensate the abnormally exposed area when the six times the variance is less than 1.

In the compensation method for the display panel provided by an embodiment of the present application, the step of using the sum of the product of the quotient value multiplied by the compensation factor and the value to be compensated to compensate the abnormally exposed area includes: using a sum of a product of a negative quotient value multiplied by the compensation factor and the value to be compensated to compensate the abnormally exposed area when the value to be compensated is greater than the standard compensation value; and using a sum of a product of a positive quotient value multiplied by the compensation factor and the value to be compensated to compensate the abnormally exposed area when the value to be compensated is less than the standard compensation value.

Another embodiment of the present application also provides a compensation method for a display panel, including: acquiring a location information of multiple lenses in an exposure tool; determining a location information of an abnormally exposed area in a target panel according to a location information of an overlapping exposed area between of adjacent ones of the lenses; acquiring a compensation table corresponding to the target panel, and determining a value to be compensated corresponding to the location information of the abnormally exposed area in the compensation table according to the location information of the abnormally exposed area; setting a compensation data of a first area in the compensation table as a standard compensation value, wherein the first area is located in a normally exposed area; compensating the abnormally exposed area according to a difference between the value to be compensated and the standard compensation value.

In the compensation method for the display panel provided by an embodiment of the present application, the step of acquiring the compensation table corresponding to the target panel includes: acquiring a location information of each of the display panel in the display panel sample and a compensation value corresponding to each of the location information; determining a mean compensation value corresponding to each of the location information according to the location information of each of the display panel and the compensation value corresponding to each of the location information; and determining a compensation table corresponding to the target panel according to each of the location information and the mean compensation value corresponding to each of the location information.

In the compensation method for the display panel provided by an embodiment of the present application, the step of setting the compensation data of the first area in the compensation table as a standard compensation value, and the first area is located in the normally exposed area includes: determining a location information of the normally exposed area in the compensation table and a compensation data corresponding to the location information of the normally exposed area according to the location information of the abnormally exposed area in the compensation table; and selecting the compensation data of the first area in the normally exposed area to setting the compensation data of the first area as a standard compensation value.

In the compensation method for the display panel provided by an embodiment of the present application, the first area is a central area of the normally exposed area.

In the compensation method for the display panel provided by an embodiment of the present application, the step of compensating the abnormally exposed area according to the difference between the value to be compensated and the standard compensation value includes: setting a compensation factor, the compensation factor being a minimum compensation value; determining a quotient value of a difference divided by the compensation factor according to the difference between the value to be compensated and the standard compensation value; and calculating a variance of multiple quotient values; using a sum of a product of the quotient value multiplied by the compensation factor and the value to be compensated to compensate the abnormally exposed area when six times the variance is greater than or equal to 1; and using the value to be compensated to compensate the abnormally exposed area when the six times the variance is less than 1.

In the compensation method for the display panel provided by an embodiment of the present application, the step of using the sum of the product of the quotient value multiplied by the compensation factor and the value to be compensated to compensate the abnormally exposed area includes: using a sum of a product of a negative quotient value multiplied by the compensation factor and the value to be compensated to compensate the abnormally exposed area when the value to be compensated is greater than the standard compensation value; and using a sum of a product of a positive quotient value multiplied by the compensation factor and the value to be compensated to compensate the abnormally exposed area when the value to be compensated is less than the standard compensation value.

An embodiment of the present application further provides a display device, including a first acquisition module configured to acquire a location information of an abnormally exposed area in a target panel; a second acquisition module configured to acquire a compensation table corresponding to the target panel, and determine a value to be compensated corresponding to the location information of the abnormally exposed area in the compensation table according to the location information of the abnormally exposed area; a setting module configured to set a compensation data of a first area in the compensation table as a standard compensation value, wherein the first area is located in a normally exposed area; and a compensation module configured to compensate the abnormally exposed area according to a difference between the value to be compensated and the standard compensation value.

In the display device provided in an embodiment of the present application, the first acquisition module includes: a first acquisition unit configured to acquire a location information of multiple lenses in an exposure tool; and an abnormality determination unit configured to determine a location information of an abnormally exposed area in a target panel according to the location information of an overlapping exposed area between of adjacent ones of the lenses.

In the display device provided in an embodiment of the present application, the second acquisition module includes: a second acquisition unit configured to acquire a location information of each of the display panel in the display panel sample and a compensation value corresponding to each of the location information; a mean value calculation unit configured to determine a mean compensation value corresponding to each of the location information according to the location information of each of the display panel and the compensation value corresponding to each of the location information; and a compensation table generating unit configured to determine a compensation table corresponding to the target panel according to each of the location information and the mean compensation value corresponding to each of the location information.

In the display device provided in an embodiment of the present application, the setting module includes: a normal determination unit configured to determine a location information of the normally exposed area in the compensation table and a compensation data corresponding to the location information of the normally exposed area according to the location information of the abnormally exposed area in the compensation table; and a standard selection unit configured to select the compensation data of the first area in the normally exposed area and set the compensation data of the first area as a standard compensation value.

In the display device provided in an embodiment of the present application, the first area is a central area of the normally exposed area.

In the display device provided in an embodiment of the present application, the compensation module includes: a compensation factor setting unit configured to set a compensation factor, the compensation factor being a minimum compensation value; a quotient value calculation unit configured to determine a quotient value of a difference divided by the compensation factor according to the difference between the value to be compensated and the standard compensation value; a judging unit including a first judging sub-unit and a second judging sub-unit, wherein the first judging sub-unit is configured to calculate a variance of a plurality of the quotient values, and use a sum of a product of the quotient value multiplied by the compensation factor and the value to be compensated to compensate the abnormally exposed area when six times the variance is greater than or equal to 1; and the second judging sub-unit is configured to judge using the value to be compensated to compensate the abnormally exposed area when the six times the variance is less than 1.

In the display device provided in an embodiment of the present application, the first judgment sub-unit includes: a negative compensation sub-unit configured to determine using a sum of a product of a negative quotient value multiplied by the compensation factor and the value to be compensated to compensate the abnormally exposed area when the value to be compensated is greater than the standard compensation value.

In the display device provided in an embodiment of the present application, the first judgment sub-unit further includes: a positive compensation sub-unit configured to determine using a sum of a product of a positive quotient value multiplied by the compensation factor and the value to be compensated to compensate the abnormally exposed area when the value to be compensated is less than the standard compensation value.

An embodiment of the present application provides a compensation method for a display panel, which includes: acquiring a location information of an abnormally exposed area in a target panel; acquiring a compensation table corresponding to the target panel, and determining a value to be compensated corresponding to the location information of the abnormally exposed area in the compensation table according to the location information of the abnormally exposed area; setting a compensation data of a first area in the compensation table as a standard compensation value, wherein the first area is located in a normally exposed area; and compensating the abnormally exposed area according to a difference between the value to be compensated and the standard compensation value. In the present application, by determining the value to be compensated corresponding to the location information of the abnormally exposed area, lens mura can be specifically repaired; and by setting the standard compensation value, and compensating the abnormally exposed area according to the difference between the value to be compensated and the standard compensation value, a demura ratio can be reduced, thereby increasing production capacity, reducing shift and deterioration of the lens mura position, thus optimizing the mean value compensation effect.

### BRIEF DESCRIPTION OF DRAWINGS

In order to more clearly illustrate the technical solutions of the embodiments of the application, the drawings illustrating the embodiments will be briefly described below.

FIG. 1 is a flowchart of a compensation method for a display panel provided by an embodiment of the present application.

FIG. 2 is a schematic diagram of a basic structure of a display panel provided by an embodiment of the present application.

FIG. 3 is a schematic diagram of principle of abnormal exposure of a display panel provided by an embodiment of the present application.

FIG. 4 is a schematic diagram of an exposed area of a display panel provided by an embodiment of the present application.

FIG. 5 is a flowchart of a compensation principle of a display panel provided by an embodiment of the present application.

FIG. 6 is a block diagram of a basic structure of a display device provided by an embodiment of the present application.

### DETAILED DESCRIPTION OF PREFERRED EMBODIMENTS

The technical solutions in the embodiments of the present application will be clearly and completely described below in conjunction with the drawings in the embodiments of the present application. In the drawings, for clarity and ease of understanding and description, the sizes and thicknesses of the components shown in the drawings are not drawn to scale.

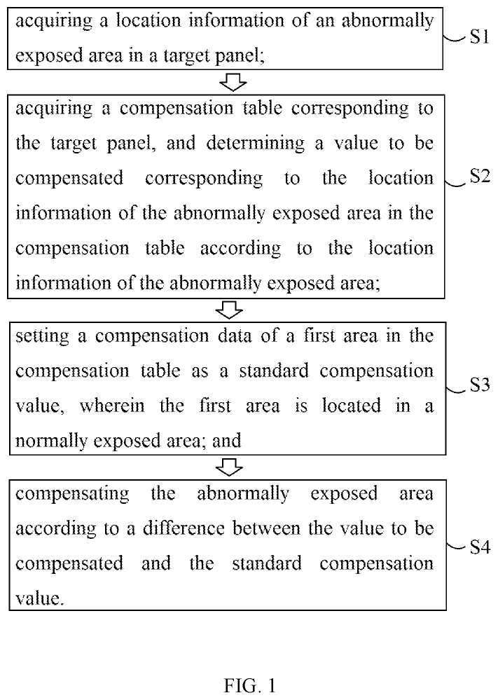

As shown in FIG. 1, FIG. 1 is a flowchart of a compensation method for a display panel provided by an embodiment of the present application, and the compensation method for the display panel includes:

S1, acquiring a location information of an abnormally exposed area in a target panel;

S2, acquiring a compensation table corresponding to the target panel, and determining a value to be compensated corresponding to the location information of the abnormally exposed area in the compensation table according to the location information of the abnormally exposed area;

S3, setting a compensation data of a first area in the compensation table as a standard compensation value, wherein the first area is located in a normally exposed area; and

S4, compensating the abnormally exposed area according to a difference between the value to be compensated and the standard compensation value.

It should be noted that in order to increase production capacity and reduce a demura ratio, the existing technology takes a mean value from limited samples and uses the mean value to compensate the display panel, wherein the mean value is to average influence factors of a total sample, resulting in lens mura generated in an position where there is no lens mura originally, that is, a position of lens mura is prone to shift, resulting in poor compensation. In the present application, by determining the value to be compensated corresponding to the location information of the abnormally exposed area, lens mura can be specifically repaired; and by selecting the standard compensation value in the normal exposed area, based on the standard compensation value, and according to the difference between the value to be compensated and the standard compensation value which is used as a constraint condition of the value to be compensated, so as to compensate the abnormally exposed area, thereby reducing the demura ratio and increasing the production capacity. By judging whether the difference between the value to be compensated and the standard compensation value meets the constraint condition of the value to be compensated to determine whether compensation is conducted according to the value to be compensated, the shift and deterioration in position of the lens mura can be reduced, thereby optimizing the mean value compensation effect.

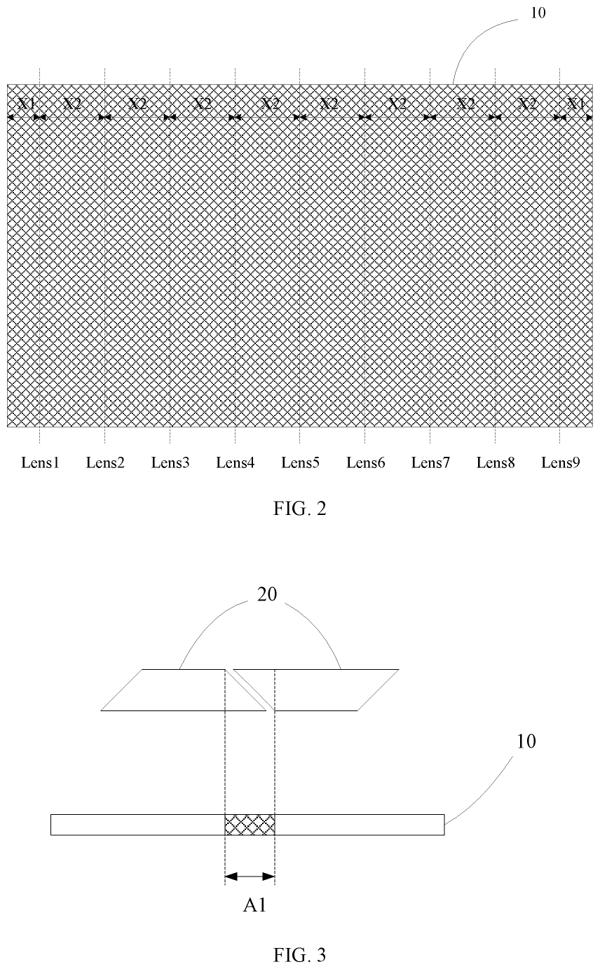

Specifically, as shown in FIG. 2 and FIG. 3, FIG. 2 is a schematic diagram of a basic structure of a display panel provided by an embodiment of the present application, and FIG. 3 is a schematic diagram of principal of abnormal exposure of a display panel provided by an embodiment of the present application. In the display panel 10 in an exposure process, since there will be an overlapping exposed area between adjacent ones of the lenses 20 (that is, an abnormally exposed area A1), it will cause lens mura to appear on the display panel 10. As shown in FIG. 2, each of Lens 1 to Lens 9 indicates lens mura, where each of X1 and X2 indicates a width of the lens 20.

It should be noted that a dotted line in FIG. 2 only indicates a position where lens mura appears, and the actual lens mura has a certain width as illustrated by the abnormally exposed area A1 in FIG. 3.

In an embodiment, the step of acquiring the location information of the abnormally exposed area in the target panel includes: acquiring a location information of multiple lenses in an exposure tool; and determining a location information of an abnormally exposed area in a target panel according to a location information of an overlapping exposed area between of adjacent ones of the lenses.

It is appreciated that, in an embodiment of the present application, the location information of the overlapping exposed area between adjacent ones of the lenses can be determined by first determining the location information of the multiple lenses in the exposure tool, wherein the location information of the overlapping exposed area corresponds to the location information of the abnormally exposed area on the display panel, so that the location information of the abnormally exposed area on the display panel can be determined by determining the location information of the lenses in the exposure tool.

It is appreciated that, in an embodiment of the present application, because the location information of the abnormally exposed area on the display panel can be determined, the value to be compensated corresponding to the location information of the abnormally exposed area can be found from the compensation table, so that the value to be compensated of the abnormally exposed area can be determined, and the compensation value at the position of the lens mura position can be specifically optimized, thereby optimizing the mean value compensation effect.

Still referring to FIG. 1, in an embodiment, the step of acquiring the compensation table corresponding to the target panel includes: acquiring a location information of each of the display panel in the display panel sample and a compensation value corresponding to each of the location information; determining a mean compensation value corresponding to each of the location information according to the location information of each of the display panel and the compensation value corresponding to each of the location information; and determining a compensation table corresponding to the target panel according to each of the location information and the mean compensation value corresponding to each of the location information

It should be noted that the display panel samples refer to sampling of a limited number of display panels from multiple display panels in a same batch, and then the demura process is performed on the display panel samples to acquire the compensation values, then the compensation mean value of the display panel samples is taken to form the compensation table, and other display panels that are not taken for sampling are compensated directly using this compensation table without an additional demura process, which can reduce the process flow and increase the production capacity.

In detail, for example, when 100 display panels are produced in the same batch, 10 display panels are served as the display panel samples to undergo the demura process to acquire the compensation value of these 10 display panels. Each of these 10 display panels includes multiple sub-pixels, and each of the multiple sub-pixels corresponds to one location information (i.e. a horizontal and vertical coordinate). One location information corresponds to 10 compensation values. By calculating a mean value of these 10 compensation values, one compensation value corresponding to one location information can be acquired. By binding the multiple location information to the multiple compensation mean values in a one-to-one correspondence, the compensation table for these 10 display panels can be formed. The other 90 display panels that are not the display panel samples can be compensated using this compensation table without additional 90 times of the demura process, which can save 90 process flows and increase production capacity.

In an embodiment, the step of setting the compensation data of the first area in the compensation table as a standard compensation value, and the first area is located in the normally exposed area includes: determining a location information of the normally exposed area in the compensation table and a compensation data corresponding to the location information of the normally exposed area according to the location information of the abnormally exposed area in the compensation table; and selecting the compensation data of the first area in the normally exposed area to setting the compensation data of the first area as a standard compensation value.

It is appreciated that, in an embodiment of the present application, the compensation data in the normally exposed area is selected as the standard compensation value, and the difference between the value to be compensated and the standard compensation value is used as the constraint condition of the value to be compensated, which can prevent the difference between the value to be compensated and the standard compensation value from being too large, resulting in poor results after compensation.

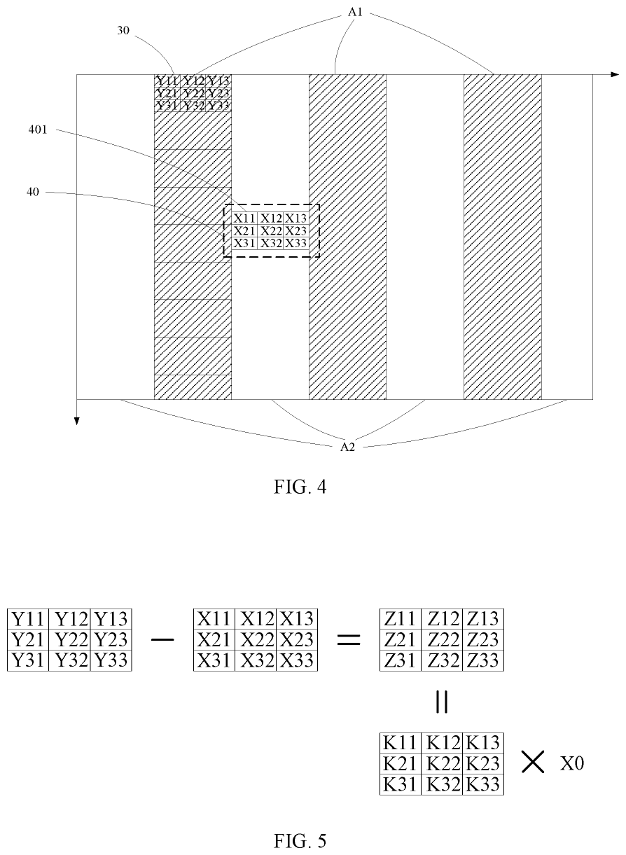

Specifically, as shown in FIG. 4, FIG. 4 is a schematic diagram of an exposed area of a display panel provided by an embodiment of the present application, wherein the display panel includes an abnormally exposed area A1 and a normally exposed area A2. In the present application, the value 30 to be compensated in the abnormally exposed area A1 need to be determined by selecting the compensation data in the first area 40 in the normally exposed area A2 as the standard compensation value 401, and then compensating the abnormally exposed area A1 according to the difference between the value 30 to be compensated and the standard compensation value 401 is used as the constraint condition of the value 30 to be compensated.

It is appreciated that in an embodiment of the present application, the location information of the lens in the exposure tool is used to determine the location information of the abnormally exposed area A1 on the display panel; then the location information of the abnormally exposed area A1 is excluded to acquire the location information of the normally exposed area A2; then the location information of the normally exposed area A2 is used to acquire the compensation data corresponding to the location information of the normally exposed area A2 in the compensation table. The standard compensation value 401 in the normally exposed area A2 is selected as a reference to constrain the value to be compensated of in the abnormally exposed area A1.

In an embodiment, the first area 40 is a central area of the normally exposed area A2. That is, the center position of the normally exposed area A2 is selected to be the first area 40. For example, an area where 100*100 sub-pixels are arranged in a center position are selected as the center area. In other embodiments, the mean compensation value with the largest proportion of the compensation data in the normally exposed area A2 may be selected as the standard compensation value, or the mean value of all compensation data in the normally exposed area A2 may be selected as the standard compensation value.

Still referring to FIG. 1, in an embodiment, the step of compensating the abnormally exposed area according to the difference between the value to be compensated and the standard compensation value includes: setting a compensation factor, the compensation factor being a minimum compensation value; determining a quotient value of a difference divided by the compensation factor according to the difference between the value to be compensated and the standard compensation value; and compensating the abnormally exposed area according to the product of the quotient value multiplied by the compensation factor when the quotient value is greater than or equal to a first threshold value.

It should be noted that the compensation factor is the minimum compensation value, that is, the minimum value that causes mura. For example, the standard brightness is 100. When the actual brightness is less than 96 or greater than 104, mura starts to appear, that is, the corresponding minimum value that causes mura is 4, that is, the compensation factor is equal to 4.

It is appreciated that an embodiment of the present application first calculates the difference between the value to be compensated and the standard compensation value, and then converts the difference into an integer multiple of the compensation factor (that is, the quotient), and then judges the quotient, and compensates the abnormally exposed area. When the difference between the compensation value and the standard compensation value is too large, the compensation value can be optimized to improve the mean value compensation effect.

Specifically, FIG. 5 shows the flow chart of the compensation principle of the display panel provided by an embodiment of the present application. First, it is necessary to calculate the difference Zij between the compensation value Yij and the standard compensation value Xij, and then convert Zij into Kij and compensation. The product of the factor X0, that is, the above-mentioned difference Zij is converted into an integer multiple expression of X0, Zij=Kij*X0, where i, j, and Kij are positive integers. In this embodiment, i is less than 4 and j is less than 4 as an example for description. Then by judging Kij, the abnormally exposed area is compensated.

In an embodiment, the step of compensating the abnormally exposed area according to the product of the quotient value multiplied by the compensation factor when the quotient value is greater than or equal to a first threshold value includes: calculating a variance of a plurality of the quotient values, and using a sum of a product of the quotient value multiplied by the compensation factor and the value to be compensated to compensate the abnormally exposed area when six times the variance is greater than or equal to 1.

It should be noted that a formula for calculating the variance is E(X)=1/n[(X₁−m)²+(X₂−m)²+ . . . +(Xₙ−m)²], wherein m is a sum of X1 to Xn and then divided by n, that is, a mean value of X1 to Xn. That is, the variance E(K) of multiple quotient values Kij=1/9[(K11−m)²+(K12−m)²+ . . . +(K33−m)²], wherein m is a sum of K11 to K33 and then divided by 9, that is, a mean value of K11, K12, K13, K21, K22, K23, K31, K32, and K33.

It is appreciated that in an embodiment of the present application, the variance of the quotient value is calculated to acquire a deviation degree of the value to be compensated. When the deviation of the value to be compensated is relatively large, the product of the quotient multiplied by the compensation factor is used to optimize the value to be compensated, which can reduce the deviation degree of the value to be compensated, thereby optimizing the mean compensation effect.

In an embodiment, if the quotient is greater than or equal to a first threshold, the step of compensating the abnormally exposed area according to the product of the quotient value multiplied by the compensation factor when the quotient value is greater than or equal to a first threshold value includes: using the value to be compensated to compensate the abnormally exposed area when the six times the variance is less than 1.

It is appreciated that if the difference between the value to be compensated and the standard compensation value is relatively small (that is, the deviation of the value to be compensated is relatively small), specifically when six times the above variance is less than 1, the value to be compensated is used to compensate the display panel, and will not cause shift and deterioration of lens mura.

In an embodiment, the step of sing a sum of a product of the quotient value multiplied by the compensation factor and the value to be compensated to compensate the abnormally exposed area includes: using a sum of a product of a negative quotient value multiplied by the compensation factor and the value to be compensated to compensate the abnormally exposed area when the value to be compensated is greater than the standard compensation value; and using a sum of a product of a positive quotient value multiplied by the compensation factor and the value to be compensated to compensate the abnormally exposed area when the value to be compensated is less than the standard compensation value.

It is appreciated that when the difference between the value to be compensated and the standard compensation value is relatively large (that is, the deviation of the value to be compensated is relatively large), specifically, when six times the above variance is greater than or equal to 1, the compensation value needs to be optimized. The positive compensation is used to optimize a value lower than the standard compensation value, and the negative compensation is used to optimize a value higher than the standard compensation value.

Specifically, by adopting negative compensation to optimize the value to be compensated that deviates upward (higher than the standard compensation value), and adopting positive compensation to optimize the value to be compensated that deviates downward (lower than the standard compensation value), data that does not conform to a normal distribution can be adjusted to data conforming to the normal distribution, and the problem of inconsistent distribution of different lens mura compensation data caused by sample sizes and screen errors can be fixed to improve the mean compensation effect.

It should be noted that the compensation table generated by the data after compensation by the compensation method provided in an embodiment of the present application can be directly copied into a flash (memory) in a printing factory, without the need to go to the factory for the demura process, which can reduce the process flow and increase the production capacity.

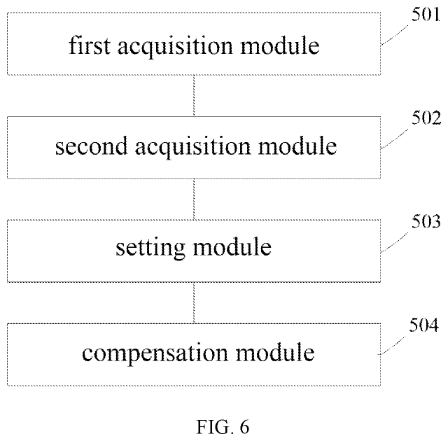

Next, referring to FIG. 6, FIG. 6 is a block diagram of a basic structure of a display device provided by an embodiment of the present application. The display device includes a first acquisition module 501, a second acquisition module 502, a setting module 503, and a compensation module 504. The first acquiring module 501 is configured to acquire a location information of the abnormally exposed area in s target panel; the second acquisition module 502 is configured to acquire a compensation table corresponding to the target panel, and determine a value to be compensated corresponding to the location information of the abnormally exposed area in the compensation table according to the location information of the abnormally exposed area; the setting module 503 is configured to set a compensation data of a first area in the compensation table as a standard compensation value, wherein the first area is located in a normally exposed area; and the compensation module 504 is configured to compensate the abnormally exposed area according to a difference between the value to be compensated and the standard compensation value.

The display device is used to implement the compensation method for the display panel as described in FIGS. 1 to 5.

In an embodiment, the first acquiring module includes a first acquisition unit and an abnormality determination unit, wherein the first acquisition unit is configured to acquire a location information of multiple lenses in an exposure tool; and the abnormality determination unit is configured to determine a location information of an abnormally exposed area in a target panel according to the location information of an overlapping exposed area between of adjacent ones of the lenses.

In an embodiment, the second acquisition module includes a second acquisition unit, an mean value calculation unit, and a compensation table generation unit, wherein the second acquisition unit is configured to acquire a location information of each of the display panel in the display panel sample and a compensation value corresponding to each of the location information; the mean value calculation unit is configured to determine a mean compensation value corresponding to each of the location information according to the location information of each of the display panel and the compensation value corresponding to each of the location information; and the compensation table generating unit is configured to determine a compensation table corresponding to the target panel according to each of the location information and the mean compensation value corresponding to each of the location information.

In an embodiment, the setting module includes a normal determination unit and a standard selection unit, wherein the normal determination unit is configured to determine a location information of the normally exposed area in the compensation table and a compensation data corresponding to the location information of the normally exposed area according to the location information of the abnormally exposed area in the compensation table; and the standard selection unit is configured to select the compensation data of the first area in the normally exposed area and set the compensation data of the first area as a standard compensation value.

In an embodiment, the first area is a central area of the normally exposed area. That is, the center position of the normally exposed area is selected to be the first area. For example, an area where 100*100 sub-pixels are arranged in a center position are selected as the center area. In other embodiments, the mean compensation value with the largest proportion of the compensation data in the normally exposed area may be selected as the standard compensation value, or the mean value of all compensation data in the normally exposed area may be selected as the standard compensation value.

In an embodiment, the compensation module includes a compensation factor setting unit, a quotient value calculation unit, and a judgment unit, wherein the compensation factor setting unit is configured to set a compensation factor, and the compensation factor is a minimum compensation value; the quotient value calculation unit is configured to determine a quotient value of a difference divided by the compensation factor according to the difference between the value to be compensated and the standard compensation value; and the judging unit is configured to determine compensating the abnormally exposed area according to the product of the quotient value multiplied by the compensation factor when the quotient value is greater than or equal to a first threshold value.

In an embodiment, the judging unit includes a first judging sub-unit, and the first judging sub-unit is configured to calculate a variance of a plurality of the quotient values, and use a sum of a product of the quotient value multiplied by the compensation factor and the value to be compensated to compensate the abnormally exposed area when six times the variance is greater than or equal to 1

In an embodiment, the judging unit further includes a second judging sub-unit, and the second judging sub-unit is configured to judge using the value to be compensated to compensate the abnormally exposed area when the six times the variance is less than 1.

In an embodiment, the first judgment sub-unit includes a negative compensation sub-unit and a positive compensation sub-unit, wherein the negative compensation sub-unit is configured to determine using a sum of a product of a negative quotient value multiplied by the compensation factor and the value to be compensated to compensate the abnormally exposed area when the value to be compensated is greater than the standard compensation value; and the positive compensation sub-unit is configured to determine using a sum of a product of a positive quotient value multiplied by the compensation factor and the value to be compensated to compensate the abnormally exposed area when the value to be compensated is less than the standard compensation value.

It should be noted that the display device provided by an embodiment of the present application may be a product or component with a display function, such as a mobile phone, a tablet computer, a notebook computer, a television, a digital camera, a navigator. etc.

In summary, an embodiment of the present application provides a compensation method for a display panel, which includes: acquiring a location information of an abnormally exposed area in a target panel; acquiring a compensation table corresponding to the target panel, and determining a value to be compensated corresponding to the location information of the abnormally exposed area in the compensation table according to the location information of the abnormally exposed area; setting a compensation data of a first area in the compensation table as a standard compensation value, wherein the first area is located in a normally exposed area; and compensating the abnormally exposed area according to a difference between the value to be compensated and the standard compensation value. In the present application, by determining the value to be compensated corresponding to the location information of the abnormally exposed area, lens mura can be specifically repaired; and by setting the standard compensation value, and compensating the abnormally exposed area according to the difference between the value to be compensated and the standard compensation value, a demura ratio can be reduced, thereby increasing production capacity, reducing shift and deterioration of the lens mura position, thus optimizing the mean value compensation effect, and solving the technical problem of a poor compensation effect of the display panel in the prior art, which is caused by a shift in position of lens mura due to using a mean value of limited samples for compensation.

The compensation method for the display panel and the display device provided by the embodiments of the present application have been described in detail above. It should be understood that the exemplary embodiments described herein should only be considered as descriptive, to help understand the method of the present invention and its core ideas, and not to limit the present invention

What is claimed is:

1. A compensation method for a display panel, which comprises:
acquiring a location information of an abnormally exposed area in a target panel;
acquiring a compensation table corresponding to the target panel, and determining a value to be compensated corresponding to the location information of the abnormally exposed area in the compensation table according to the location information of the abnormally exposed area;
setting a compensation data of a first area in the compensation table as a standard compensation value, wherein the first area is located in a normally exposed area; and
compensating the abnormally exposed area according to a difference between the value to be compensated and the standard compensation value.

2. The compensation method for the display panel according to claim 1, wherein the step of acquiring the compensation table corresponding to the target panel comprises:
acquiring a location information of each of the display panel in the display panel sample and a compensation value corresponding to each of the location information;
determining a mean compensation value corresponding to each of the location information according to the location information of each of the display panel and the compensation value corresponding to each of the location information; and
determining a compensation table corresponding to the target panel according to each of the location information and the mean compensation value corresponding to each of the location information.

3. The compensation method for the display panel according to claim 1, wherein the step of setting the compensation data of the first area in the compensation table as a standard compensation value, and the first area is located in the normally exposed area comprises:
determining a location information of the normally exposed area in the compensation table and a compensation data corresponding to the location information of the normally exposed area according to the location information of the abnormally exposed area in the compensation table; and
selecting the compensation data of the first area in the normally exposed area to setting the compensation data of the first area as a standard compensation value.

4. The compensation method for the display panel according to claim 3, wherein the first area is a central area of the normally exposed area.

5. The compensation method for the display panel according to claim 1, wherein the step of compensating the abnormally exposed area according to the difference between the value to be compensated and the standard compensation value comprises:
setting a compensation factor, the compensation factor being a minimum compensation value;
determining a quotient value of a difference divided by the compensation factor according to the difference between the value to be compensated and the standard compensation value; and
calculating a variance of multiple quotient values; using a sum of a product of the quotient value multiplied by the compensation factor and the value to be compensated to compensate the abnormally exposed area when six times the variance is greater than or equal to 1; and using the value to be compensated to compensate the abnormally exposed area when the six times the variance is less than 1.

6. The compensation method for the display panel according to claim 5, wherein the step of using the sum of the product of the quotient value multiplied by the compensation factor and the value to be compensated to compensate the abnormally exposed area comprises:
using a sum of a product of a negative quotient value multiplied by the compensation factor and the value to be compensated to compensate the abnormally exposed area when the value to be compensated is greater than the standard compensation value; and
using a sum of a product of a positive quotient value multiplied by the compensation factor and the value to be compensated to compensate the abnormally exposed area when the value to be compensated is less than the standard compensation value.

7. A compensation method for a display panel, which comprises:
acquiring a location information of multiple lenses in an exposure tool;
determining a location information of an abnormally exposed area in a target panel according to a location information of an overlapping exposed area between of adjacent ones of the lenses;
acquiring a compensation table corresponding to the target panel, and determining a value to be compensated corresponding to the location information of the abnormally exposed area in the compensation table according to the location information of the abnormally exposed area;
setting a compensation data of a first area in the compensation table as a standard compensation value, wherein the first area is located in a normally exposed area;
compensating the abnormally exposed area according to a difference between the value to be compensated and the standard compensation value.

8. The compensation method for the display panel according to claim 7, wherein the step of acquiring the compensation table corresponding to the target panel comprises:
acquiring a location information of each of the display panel in the display panel sample and a compensation value corresponding to each of the location information;
determining a mean compensation value corresponding to each of the location information according to the location information of each of the display panel and the compensation value corresponding to each of the location information; and
determining a compensation table corresponding to the target panel according to each of the location information and the mean compensation value corresponding to each of the location information.

9. The compensation method for the display panel according to claim 7, wherein the step of setting the compensation data of the first area in the compensation table as a standard compensation value, and the first area is located in the normally exposed area comprises:
determining a location information of the normally exposed area in the compensation table and a compensation data corresponding to the location information of the normally exposed area according to the location information of the abnormally exposed area in the compensation table; and
selecting the compensation data of the first area in the normally exposed area to setting the compensation data of the first area as a standard compensation value.

10. The compensation method for the display panel according to claim 9, wherein the first area is a central area of the normally exposed area.

11. The compensation method for the display panel according to claim 7, wherein the step of compensating the abnormally exposed area according to the difference between the value to be compensated and the standard compensation value comprises:
setting a compensation factor, the compensation factor being a minimum compensation value;
determining a quotient value of a difference divided by the compensation factor according to the difference between the value to be compensated and the standard compensation value; and
calculating a variance of multiple quotient values; using a sum of a product of the quotient value multiplied by the compensation factor and the value to be compensated to compensate the abnormally exposed area when six times the variance is greater than or equal to 1; and using the value to be compensated to compensate the abnormally exposed area when the six times the variance is less than 1.

12. The compensation method for the display panel according to claim 11, wherein the step of using the sum of the product of the quotient value multiplied by the compensation factor and the value to be compensated to compensate the abnormally exposed area comprises:
using a sum of a product of a negative quotient value multiplied by the compensation factor and the value to be compensated to compensate the abnormally exposed area when the value to be compensated is greater than the standard compensation value; and
using a sum of a product of a positive quotient value multiplied by the compensation factor and the value to be compensated to compensate the abnormally exposed area when the value to be compensated is less than the standard compensation value.

13. A display device, comprising:
a first acquisition module configured to acquire a location information of an abnormally exposed area in a target panel;
a second acquisition module configured to acquire a compensation table corresponding to the target panel, and determine a value to be compensated corresponding to the location information of the abnormally exposed area in the compensation table according to the location information of the abnormally exposed area;
a setting module configured to set a compensation data of a first area in the compensation table as a standard compensation value, wherein the first area is located in a normally exposed area; and
a compensation module configured to compensate the abnormally exposed area according to a difference between the value to be compensated and the standard compensation value.

14. The display device according to claim 13, wherein the first acquisition module comprises:
a first acquisition unit configured to acquire a location information of multiple lenses in an exposure tool; and
an abnormality determination unit configured to determine a location information of an abnormally exposed area in a target panel according to the location information of an overlapping exposed area between of adjacent ones of the lenses.

15. The display device according to claim 13, wherein the second acquisition module comprises:
a second acquisition unit configured to acquire a location information of each of the display panel in the display panel sample and a compensation value corresponding to each of the location information;
a mean value calculation unit configured to determine a mean compensation value corresponding to each of the location information according to the location information of each of the display panel and the compensation value corresponding to each of the location information; and
a compensation table generating unit configured to determine a compensation table corresponding to the target panel according to each of the location information and the mean compensation value corresponding to each of the location information.

16. The display device according to claim 13, wherein the setting module comprises:
a normal determination unit configured to determine a location information of the normally exposed area in the compensation table and a compensation data corresponding to the location information of the normally exposed area according to the location information of the abnormally exposed area in the compensation table; and
a standard selection unit configured to select the compensation data of the first area in the normally exposed area and set the compensation data of the first area as a standard compensation value.

17. The display device according to claim 16, wherein the first area is a central area of the normally exposed area.

18. The display device according to claim 13, wherein the compensation module comprises:
a compensation factor setting unit configured to set a compensation factor, the compensation factor being a minimum compensation value;
a quotient value calculation unit configured to determine a quotient value of a difference divided by the compensation factor according to the difference between the value to be compensated and the standard compensation value;
a judging unit comprising a first judging sub-unit and a second judging sub-unit, wherein the first judging sub-unit is configured to calculate a variance of a plurality of the quotient values, and use a sum of a product of the quotient value multiplied by the compensation factor and the value to be compensated to compensate the abnormally exposed area when six times the variance is greater than or equal to 1; and the second judging sub-unit is configured to judge using the value to be compensated to compensate the abnormally exposed area when the six times the variance is less than 1.

19. The display device according to claim 18, wherein the first judgment sub-unit comprises:
a negative compensation sub-unit configured to determine using a sum of a product of a negative quotient value multiplied by the compensation factor and the value to be compensated to compensate the abnormally exposed area when the value to be compensated is greater than the standard compensation value.

20. The display device according to claim 19, wherein the first judgment sub-unit further comprises:
a positive compensation sub-unit configured to determine using a sum of a product of a positive quotient value multiplied by the compensation factor and the value to be compensated to compensate the abnormally exposed area when the value to be compensated is less than the standard compensation value.
